(19) United States
(12) Patent Application Publication
(10) Pub. No.: US 2020/0126087 A1
(43) Pub. Date: Apr. 23, 2020

(54) SYSTEMS AND METHODS FOR AVAILABLE CREDIT NOTIFICATION BASED ON CUSTOMER LOCATION

(71) Applicant: Capital One Services, LLC, McLean, VA (US)

(72) Inventors: Abdelkader M'Hamed Benkreira, Washington, DC (US); Joshua Edwards, Philadelphia, PA (US); Michael Mossaba, Arlington, VA (US)

(73) Assignee: Capital One Services, LLC, McLean, VA (US)

(21) Appl. No.: 16/163,962

(22) Filed: Oct. 18, 2018

(51) Int. Cl. G06Q 20/40; G06Q 20/42; G06Q 20/24; H04W 4/021

(52) U.S. Cl. CPC G06Q 20/4037; H04W 4/021; G06Q 20/24; G06Q 20/42

(57) ABSTRACT

A system for location based available credit notification includes one or more processors configured to execute the instructions to determine a customer location and a customer identity based on a response from the user device to a location access request; determine an available credit associated with the customer; access customer specific information and merchant data based on at least one of the determined available credit, the customer location, and the customer identity; wherein the customer specific information includes at least one of customer transaction data or customer mobility data; predict, by a prediction model if the customer is going to make a purchase and, if so, a monetary amount of the purchase; determine if the predicted monetary amount of the purchase exceeds the available credit; and transmit a notification to the user device upon determining that the predicted monetary amount of the transaction exceeds the available credit.

### TECHNICAL FIELD

Embodiments of the present disclosure relate to systems and methods for a credit service provider communicating with a customer. More particularly, embodiments of the present disclosure relate to using location of a customer by a credit service provider system to predict when the customer may make a purchase that exceeds a available credit and provides a notification to the customer when the purchase is predicted.

### BACKGROUND

Customers often make transactions, such as purchases of goods and services at different retail locations using their credit cards, but may not be aware of an available credit on their credit cards. When a customer travels to a brick and mortar retail location with an intention of making a credit card purchase, there is a possibility that the credit card may be declined. There are many reasons for the credit card getting declined. However, a common reason for declining is that the purchase transaction exceeds the customer's available credit. The customer may find having their credit card declined to be an uncomfortable situation. In such a situation, the customer may end up using other forms of payment such as using a credit card from a different credit service provider or even paying with cash. This may result in embarrassment to the customer and loss of revenue for the credit service provider.

To avoid such an uncomfortable situation, the customer could check their available credit before making a purchase by using either a mobile application, accessing a website of the credit service provider or calling the credit service provider to request available credit information. In these situations, the credit service provider may allow the customer to spend above their available credit to avoid declining the purchase transaction.

### SUMMARY

In accordance with embodiments of the present disclosure, there is provided a system for location based available credit notification, the system comprising: one or more memory devices storing instructions; and one or more processors in communication with one or more databases configured to execute the instructions to: determine a customer location and a customer identity, associated with a user device of a customer of a credit service provider, based on a response from the user device to a location access request by the one or more processors; determine an available credit associated with the customer based on the determined customer identity; access customer specific information and merchant data based on at least one of the determined available credit, the customer location, and the customer identity; wherein the customer specific information and merchant data are accessed in the one or more database and wherein the customer specific information includes at least one of customer transaction data or customer mobility data; predict, by a prediction model using the customer specific information and the merchant data, if the customer is going to make a purchase and, if so, a monetary amount of the purchase; determine if the predicted monetary amount of the purchase exceeds the available credit associated with the customer; and transmit a notification to the user device upon determining that the predicted monetary amount of the transaction exceeds the available credit.

In accordance with embodiments of the present disclosure, there is also provided a computer implemented method for location based available credit notification, the method comprising: determining, by one or more processors, a customer location and a customer identity, associated with a user device of a customer of a credit service provider, based on a response from the user device to a location access request; determining an available credit associated with the customer based on the determined customer identity; accessing customer specific information and merchant data based on at least one of the determined available credit, the customer location, and the customer identity; wherein the customer specific information and merchant data are accessed in the one or more databases, and wherein the customer specific information includes at least one of customer transaction data or customer mobility data; predicting, by a prediction model using the customer specific information and merchant data, if the customer is going to make a purchase and, if so, a monetary amount of the purchase; determining if the predicted monetary amount of the purchase exceeds the available credit associated with the customer; and transmitting a notification to the user device upon determining that the predicted monetary amount of the transaction exceeds the available credit.

In accordance with embodiments of the present disclosure, there is further provided a non-transitory computer-readable medium storing instructions executable by one or more processors to perform operations for location based available credit notification, the operations comprising: determining a customer location and a customer identity, associated with a user device of a customer of a credit service provider, based on a response from the user device to a location access request; determining an available credit associated with the customer based on the determined customer identity; accessing customer specific information and merchant data based on at least one of the determined available credit, the customer location, and the customer identity; wherein the customer specific information and merchant data are accessed in the one or more databases, and wherein the customer specific information includes at least one of customer transaction data or customer mobility data; predicting, by a prediction model using the customer specific information and merchant data, if the customer is going to make a purchase and, if so, a monetary amount of the purchase; determining if the predicted monetary amount of the purchase exceeds the available credit associated with the customer; and transmitting a notification to the user device upon determining that the predicted monetary amount of the transaction exceeds the available credit.

### BRIEF DESCRIPTION OF DRAWINGS

The accompanying drawings, which are incorporated in and constitute a part of this specification, illustrate disclosed embodiments and, together with the description, serve to explain the disclosed embodiments. In the drawings:

FIG. 1 is a block diagram of an exemplary system, consistent with disclosed embodiments.

FIG. 2 is a block diagram of an exemplary user device, consistent with disclosed embodiments.

FIG. 3 is a block diagram of an exemplary server system, consistent with disclosed embodiments.

FIG. 4 is a flowchart of an exemplary process, consistent with disclosed embodiments.

FIG. 5 is a flowchart of an exemplary process, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

An initial overview of machine learning and prediction is first provided immediately below and then specific exemplary embodiments of systems, methods, and devices for available credit notification based on customer location are described in further detail. The initial overview is intended to aid in understanding some of the technology relevant to the systems, methods, and devices disclosed herein, but it is not intended to limit the scope of the claimed subject matter.

In the world of machine prediction, there are two subfields knowledge-based systems and machine-learning systems. Knowledge-based approaches rely on the creation of a heuristic or rule-base which is then systematically applied to a particular problem or dataset. Knowledge based systems make inferences or decisions based on an explicit “if-then” rule system. Such systems rely on extracting a high degree of knowledge about a limited category to virtually render all possible solutions to a given problem. These solutions are then written as a series of instructions to be sequentially followed by a machine.

Machine learning systems, unlike the knowledge-based systems, provide machines with the ability to learn through data input without being explicitly programmed with rules. For example, as just discussed, conventional knowledge-based programming relies on manually writing algorithms (i.e., rules) and programming instructions to sequentially execute the algorithms. Machine learning systems, on the other hand, avoid following strict sequential programming instructions by making data-driven decisions to construct their own rules. The nature of machine learning is the iterative process of using rules, and creating new ones, to identify unknown relationships to better generalize and handle non-linear problems with incomplete input data sets. A detailed explanation of one such machine learning technique is disclosed in the article: Michalski, R. S., Stepp, R. E. “Learning from Observation: Conceptual Clustering,” Chapter 11 of Machine Learning: An Artificial Intelligence Approach, eds. R. S. Michalski, J. G. Carbonell and T. M. Mitchell, San Mateo: Morgan Kaufmann, 1983. Embodiments of the present disclosure implement a prediction model which uses machine learning.

While the following discussion is directed to financial services in a retail or merchant environment, discussion of these services and environments are made by example only. It should be appreciated, however, that the present disclosure is not limited to these specific embodiments and details, which are exemplary only. It is further understood that one possessing ordinary skill in the art, in light of known systems and methods, would appreciate the use of the embodiments of the present disclosure for their intended purposes and benefits in any number of alternative embodiments, depending on specific design and other needs. The systems and methods discussed herein may be just as applicable in other environments that may benefit from the ability to determine a customer's location and/or provide notifications/information to the customer.

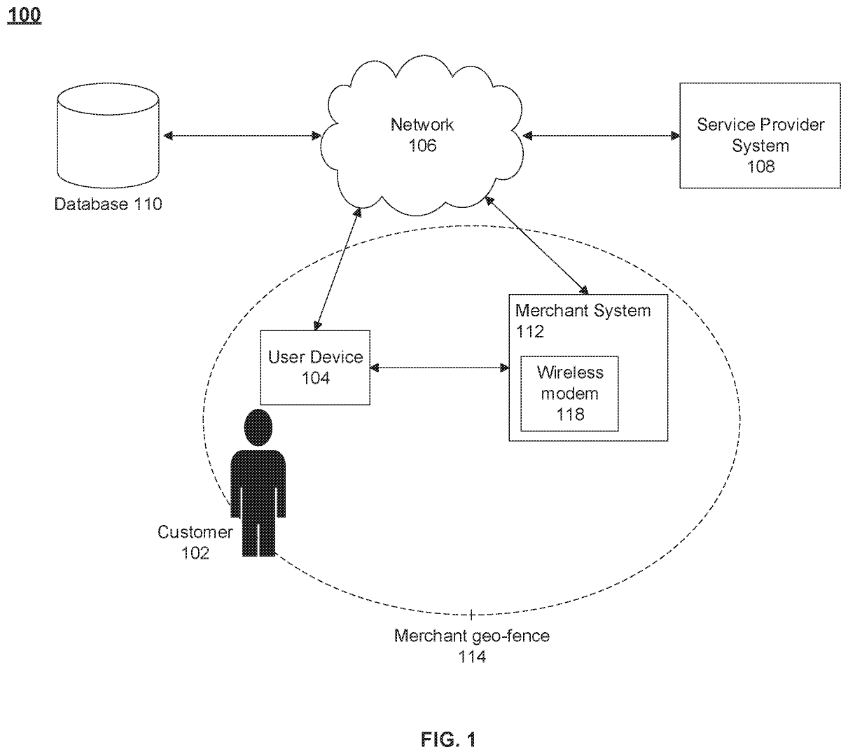

FIG. 1 is a block diagram of an exemplary system 100, for performing one or more operations consistent with disclosed embodiments. In some embodiments, system 100 includes one or more user devices 104, one or more service provider systems 108, one or more databases 110, one or more merchant systems 112, and a network 106. The components and arrangement of the components included in system 100 may vary. Thus, system 100 may include other components that perform or assist in the performance of one or more processes consistent with the disclosed embodiments.

Components of system 100 may include one or more computing devices (e.g., computer(s), server(s), etc.), memory storing data and/or software instructions (e.g., database(s), memory devices, etc.), and other known computing components. In some embodiments, the one or more computing devices may be configured to execute software instructions stored on one or more memory devices to perform one or more operations consistent with the disclosed embodiments. Aspects of service provider system(s) 108, merchant system(s) 112, database(s) 110 and user device(s) 104 may be configured to communicate with one or more other components of system 100, via network 106, for example. In certain aspects, a customer 102 is associated with and operates user device 104 to interact with one or more components of system 100 to send and receive communications, initiate operations, and/or provide input for one or more operations consistent with the disclosed embodiments.

Components of system 100 may be configured to determine when customer 102 is at a merchant location, predict if customer 102 is going to make a credit purchase, using a credit card provided by a credit service provider associated with service provider system 108, and predict if a monetary amount of the predicted credit purchase will exceed an available credit associated with the credit card. A predicted credit purchase that will exceed the available credit to customer 102 is referred to herein as a prospective purchase event. If a prospective purchase event is predicted, service provider system 108 will provide a prospective purchase event notification to customer 102. For example, in some embodiments, aspects of service provider system 108 may be configured to periodically send a location access request to user device 104 associated with customer 102 and receive a response from user device 104 which includes location and identity information. The received location may, for example, include real-time GPS coordinates of customer 102. User device 104 may store the identity of customer 102 in memory. For example, the stored identity of customer 102 may include personal information including name; and contact details, for example, email address, telephone number, residential address, etc. The identity of customer 102 may also include financial information including bank accounts, credit card accounts, etc., associated with customer 102. Service provider system 108 may be configured to use the identity of customer 102 stored by or accessible to service provider system 108, e.g., in database 110 or user device 104 to determine a credit limit associated with customer 102. Based on the credit limit, service provider system 108 is further configured to determine an available credit of customer 102.

In some embodiments, the credit limit for customer 102 may be determined by service provider system 108 based on available bank account balance, income, credit score, credit limit utilization percentage history, late bill payments, late mortgage or rent payments, history of surpassing available credit, etc. As used herein, the available credit is an unused amount of the credit limit and is determined by service provider system 108. Based on the available credit, location, and identity of customer 102, service provider system 108 retrieves customer specific information associated with customer 102 and uses a prediction model to predict whether a prospective purchase event will occur. Alternatively, the prediction model may retrieve customer specific information associated with customer 102 and predict an occurrence of a prospective purchase event. For example, service provider system 108 identifies customer 102 and determines that customer 102 is at a merchant location. Service provider system 108 further determines the available credit customer 102. In this situation, service provider system 108 or the prediction model may retrieve customer specific information associated with customer 102 and the prediction model uses the customer specific information to predict a possible prospective purchase event.

In some embodiments, the customer specific information includes customer transaction data and customer mobility data of customer 102. In some embodiments, customer transaction data may include customer purchase history including but not limited to time of purchase, date of purchase, merchant name and/or merchant category for goods or services purchased, amount of purchase, frequency of purchase at a merchant, and/or method of purchase, for example, if the purchase was made online or at a brick and mortar location. The purchase history may also include a method of payment for each purchase, for example, if the purchase was made using credit card, debit card, checking account, savings account, net banking, PayPal®, mobile wallet, e-wallet, etc., that may be associated with service provider system 108. The customer transaction data may further include a customer refund history, for example, a frequency of obtaining refunds at a particular merchant or merchant category. Customer mobility data may include customer travel history, customer travel routes, modes of transport used by the customer, customer routine information, frequently visited locations including customer work location, customer home location, gym, restaurants, etc.

Service provider system 108 may further compile merchant data and store the merchant data, e.g., in database 110. Merchant data may include GPS coordinates of merchant locations, geofence coordinates if a geofence is associated with a merchant, other map data of merchants, merchant categories, merchant category codes, merchant hours of operation, merchant days of operation, holiday closures, and/or special hours on certain days. For example, one merchant may be open on Thanksgiving Day, while another merchant may be closed on Thanksgiving Day.

The prediction model, communicatively coupled to or included within service provider system 108, is constructed in advance using the customer specific information and merchant data available to the credit service provider and stored in database 110. System 100 may use one or more of a machine learning process or neural networks to construct the prediction model to predict whether customer 102 may make a credit purchase and a monetary amount of the purchase. System 100 may also have a machine learning algorithm incorporated such that the prediction model may be updated each time customer 102 makes a purchase or any financial transaction using a credit card provided by service provider system 108. The customer specific information is used to iteratively train the prediction model and update the algorithm to predict the possible occurrence of a prospective purchase event associated with customer 102.

Database 110 of system 100, may be communicatively coupled to service provider system(s) 108 and merchant system(s) 112 via network 106. Database 110 may include one or more memory devices that store information and are accessed and/or managed by one or more components of system 100. By way of example, database 110 may include Oracle™ databases, Sybase™ databases, or other relational databases or nonrelational databases, such as Hadoop sequence files, HBase, or Cassandra. The databases or other files may include, for example, data and information related to customer identity information, customer financial account information, customer transaction information, customer mobility data, and merchant data. Database 110 may include computing components (e.g., database management system, database server, etc.) configured to receive and process requests for data stored in memory devices of database 110 and to provide data from database 110.

Database 110 is configured to store as part of the merchant data, merchant category codes mapped to a plurality of merchant categories. More particularly, in some embodiments, service provider system 108 is configured to group one or more merchants into categories and assign a code to each category, as more fully explained below.

In some embodiments, database 110 is configured to store merchant data, as previously described. Service provider system 108 may periodically request merchant system 112 to send some or all of the merchant data. In response, merchant system 112 sends the requested merchant data to service provider system 108, and service provider system 108 updates the merchant data in database 110 accordingly.

In some embodiments, service provider system 108 periodically updates database 110 with customer specific information and personal information. In other embodiments, customer 102 optionally updates database 110 with the customer specific information and personal information. In some embodiments customer 102 may update the customer specific information and personal information manually using an application installed on user device 104, or using a web-based application. The customer specific information which customer 102 can update manually may include customer home address, work address, customer mobility data including frequently visited locations, for example, a gym, coffee shop, etc.

Service provider system 108 may be associated with a financial service entity that provides, maintains, manages, or otherwise offers financial services, including a credit service provider. For example, the financial service entity may be a bank, credit card issuer, or any other type of financial service entity that generates, provides, manages, and/or maintains financial service accounts for one or more users. Financial service accounts may include, for example, credit card accounts, loan accounts, checking accounts, savings accounts, reward or loyalty program accounts, and/or any other type of financial service account known to those skilled in the art. In providing, maintaining, managing or otherwise offering financial services, service provider system 108 may be enabled to authenticate financial transactions associated with a financial service account. Service provider system 108 may include infrastructure and components that are configured to generate and/or provide financial service accounts such as credit card accounts, checking accounts, debit card accounts, loyalty or reward programs, lines of credit, and the like.

In one aspect, service provider system 108 may include one or more computing devices, configured to perform one or more operations consistent with disclosed embodiments. In one aspect, service provider system 108 may include one or more servers or server systems. Service provider system 108 may include one or more processors configured to execute software instructions stored in a memory or other storage device. The one or more processors may be configured to execute software instructions that, when executed by a processor, perform internet-related communication, financial service-based processes, and machine learning for prediction-based notifications. Service provider system 108 may be a computing system configured to collect, store, and analyze financial data. For example, service provider system 108 may be a server configured to communicate with other components of system 100 to receive and provide customer transaction data and customer mobility data. Service provider system 108 may execute software that uses the customer transaction data, customer mobility data, and merchant data for generating and displaying credit-related notifications, including prospective purchase event notifications, on a display device included in, or connected to, user device 104. In some embodiments, service provider system 108 may provide one or more mobile applications, web-sites or online portals that are accessible by user device 104 over network 106. The disclosed embodiments are not limited to any particular configuration of service provider system 108.

For purposes of illustrating the embodiments, merchant system 112 may be an entity that offers goods, services, and/or information, such as a retailer, a grocery store, a department store, a restaurant, a shopping mall, a museum, or any other type of entity that offers goods and/or provides services. Merchant system 112 may further include a wireless modem 118. Wireless modem 118 may be one or more computing devices configured to perform one or more operations consistent with the disclosed embodiments. In some embodiments, wireless modem 118 may be a wireless access point, wireless router, or any other networking device based on IEEE 802.11 standards. In some embodiments, user device 104 may gain access to network 106 via wireless modem 118. As a result, service provider system 108 may be able to determine a location of customer 102 based on wireless modem 118 associated with merchant system 112, from which customer 102 gains network access. Wireless modem 118 may be a part of merchant system 112 or may be separate from merchant system 112.

Service provider system 108 and user device 104 may be configured to communicate with each other over network 106. Network 106 may comprise any type of computer networking arrangement configured to provide communications or exchange data, or both, between components of system 100. For example, network 106 may include any type of network (including infrastructure) that provides communications, exchanges information, and/or facilitates the exchange of information, such as the Internet, a private data network, a virtual private network using a public network, a LAN or WAN network, a Wi-Fi™ network, and/or other suitable connections that may enable information exchange among various components of system 100. Network 106 may also include a public switched telephone network (“PSTN”) and/or a wireless cellular network. Network 106 may be a secured network or unsecured network. In some embodiments, one or more components of system 100 may communicate directly through a dedicated communication link(s).

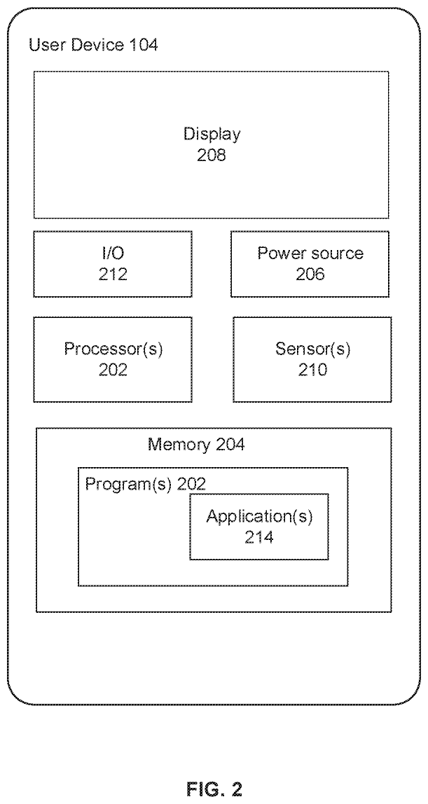

User device 104 may be one or more computing devices configured to perform one or more operations consistent with the disclosed embodiments, as described more fully below in relation to FIG. 2. User device 104 may execute browser or related mobile display software that displays credit-related notifications, including prospective purchase event notifications, on a display included in, or connected to, user device 104. User device 104 may also store and execute other mobile applications that allow customer 102 to select a method by which customer 102 wishes to receive notifications from service provider system 108.

It is to be understood that the configuration of the functional blocks of system 100 has been defined herein for convenience of description. The components and arrangement of the components included in system 100 may vary. For example, in some embodiments, system 100 may include other components that perform or assist in the performance of one or more processes consistent with disclosed methods. System 100 includes a number of components generally described as computing devices. Each of the computing devices may include any number of computing components particularly configured as a special purpose computing device to perform the functionality disclosed herein. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

FIG. 2 shows an exemplary configuration of user device 104, consistent with disclosed embodiments. User device 104 may enable a customer 102 to perform remote interactions or mobile transactions with service provider system 108, for example, or receive information from service provider system 108. In some embodiments, user device 104 may be a personal computing device. For example, user device 104 may be a smartphone, a laptop or notebook computer, a tablet, a multifunctional watch, a pair of multifunctional glasses, or any mobile or wearable device with computing ability, or any combination of these computers and/or affiliated components.

User device 104 includes one or more processors 202 configured to execute software instructions stored in memory, such as a memory 204. Memory 204 may store one or more software programs 206 that when executed by a processor 202 perform known Internet-related communication, content display processes, and other interactive processes for a customer using the user device 104. For instance, user device 104 may execute a browser or related mobile display software that generates and displays interfaces including content on a display device 208 included in, or in communication with, user device 104. User device 104 may be a mobile device that executes mobile device applications and/or mobile device communication software, included in programs 206, that allows user device 104 to communicate with service provider system 108 and other components via network 106, to generate and display content in interfaces via display device 208 included in, or in communication with, user device 104. The disclosed embodiments are not limited to any particular configuration of user device 104. User device 104 may include any arrangement of one or more computing devices configured to perform one or more operations consistent with disclosed embodiments.

User device 104 may be configured to store, in memory 204, one or more operating systems that perform known operating system functions when executed by processor 202. By way of example, the operating systems may include Microsoft Windows™, Unix™, Linux™, Android™, Apple™ Mac OS operating systems, iOS, Chrome OS, or other types of operating systems. Accordingly, disclosed embodiments may operate and function with computer systems running any type of operating system. User device 104 may also include communication software stored in memory 204 that, when executed by processor 202, provides communications with network 106, such as Web browser software, tablet or smart handheld device networking software, etc.

Display device 208 may include, for example, a liquid crystal displays (LCD), a light emitting diode screens (LED), an organic light emitting diode screen (OLED), a touch screen, and other known display devices. Display device 208 may display various information to customer 102. For example, display device 208 may display an interactive interface to customer 102 enabling customer 102 to operate user device 104 to perform certain aspects of the disclosed methods. Display device 208 may display touchable or selectable options for customer 102 to select and may receive customer selection of options through a touch screen.

User device 104 may include one or more sensors 210, including but not limited to a Global Positioning System (GPS), accelerometers, motion sensors, inertial sensors, other location sensors including Global Navigation Satellite System (GNSS), a gyroscope, pressure sensors, image sensors, proximity sensors, or any other sensors capable of providing three-dimensional location data. The data collected by one or more of the sensors 210, including velocity, altitude, elevation, direction of motion in addition to latitude and longitude coordinates, etc., may be used to determine the location of customer 102. In some embodiments, any combination of these sensors may be used to determine a position of user device 104 associated with customer 102 in a three-dimensional environment, including an indoor environment or an outdoor environment. As further explained below, consistent with disclosed embodiments, service provider system 108 requests the determined customer location from user device 104 for use in determining whether to provide a credit limit notification to customer 102.

In some embodiments, service provider system 108 periodically requests from user device 104 GPS coordinates of customer 102, determined using one or more of the sensors 210. A threshold of how often service provider system 108 requests user device 104 to provide the GPS coordinates of customer 102, may depend on a velocity of customer 102 carrying user device 104. In some embodiments, customer 102 can optionally select continuous monitoring of location. In other embodiments, customer 102 can opt in to allow service provider system 108 to access location of user device 104 at selected hours during the day, on selected days, or at a selected frequency. This customer opt-in feature may enable service provider system 108 to determine a threshold of how often service provider system 108 requests user device 104 to provide the GPS coordinates of customer 102.

In some embodiments, user device 104 uses sensors 210 to generate an elevation profile to determine location in a three-dimensional environment. User device 104 uses one or more of sensors 210 to determine elevation above ground level, typical floor height, atmospheric pressure, temperature, etc. Using the determined elevation profile, user device 104 is able to determine on which floor of a building customer 102 is located.

In some embodiments, user device 104 may be able to determine the motion direction and location of customer 102 in an indoor environment, such as a building. Using one or more of the sensors 210, user device 104 may determine where customer 102 enters a building and in which direction customer 102 is moving. Service provider system 108 uses the location determined by user device 104 to accurately identify in real time the location of customer 102 using coordinates, motion direction and/or elevation of user device. Service provider system 108 then retrieves from database 110 previously stored information, for example, coordinates, geofence data, other map data, etc., of one or more merchant locations, to determine whether a merchant exists at the identified location. In some embodiments, service provider system 108 may compare the determined location of customer 102 with the coordinates, geofence data and/or other map data of merchant locations stored in database 110 to determine if customer 102 is at a merchant location. In other embodiments, service provider system 108 may compare the mobility data of customer 102 with the coordinates, geofence data and/or other map data of merchant locations to make this determination. Using these techniques, service provider system 108 is able to accurately identify the location of customer 102 and if customer 102 is located at a merchant location, for use by the prediction model, along with the customer specific information, to predict a prospective purchase event.

In some embodiments, user device 104 is capable of using fingerprint techniques for indoor location determination. A plurality of sensors placed within an indoor space, for example, a building, a mall, etc., are capable of communicating with user device 104. User device 104 is able to track its movement within the indoor space by interacting with the plurality of sensors. The plurality of sensors placed within the indoor space may be associated with merchant system 112. Service provider system 108 may communicate with merchant system 112 and user device 104 to determine the location of customer 102 associated with user device 104.

In some embodiments, service provider system 108 can determine that user device 104, associated with customer 102, is traveling, based on the velocity of user device 104. Service provider system 108 stores customer specific information including customer mobility data, for example, customer routine, customer home location, customer work location, customer travel route information, etc. in database 110. Using this travel information, service provider system 108 can further determine whether customer 102 has arrived and is stationary at a predetermined location including but not limited to home, office, gym, etc., for a predetermined amount of time. For example, if service provider system 108 determines that customer 102 is at home or at work, the likelihood that customer 102 will visit a brick and mortar merchant location is likely very low. Based on this determination, service provider system 108 may then further determine to reduce the frequency of sending location access requests to user device 104 associated with customer 102.

In some embodiments, the frequency at which the location access request is periodically sent by service provider system 108 depends on the determined GPS coordinates of user device 104 associated with customer 102. When service provider system 108 determines, based on GPS coordinates, that customer 102 is on a shopping journey within a geofence 114, for example, at a shopping mall or a physical location hosting a plurality of merchants, it increases the frequency at which location access requests are sent to user device 104 associated with customer 102. When customer 102 is on such a shopping journey, user device 104 may optionally connect to wireless modem 118 of merchant system 112. When user device 104 receives a location access request from service provider system 108, user device 104 may provide to the service provider system 108, a network address of wireless modem 118 to which user device 104 is connected. Service provider system 108 uses the network address of wireless modem 118 to determine a location of customer 102 associated with user device 104. When customer 102 moves from one merchant location to another merchant location, while on the shopping journey, service provider system 108 is able to determine the change in the network address of wireless modem 118 and in turn determine the change in location of user device 104. For example, if user device 104 is connected to a public Wi-Fi™ at a coffee shop inside a shopping mall, service provider system 108 is able to determine the location of the user using the network address of wireless modem 118 associated with the coffee shop.

User device 104 includes I/O devices 212 that allow user device 104 to send and receive information or interactions from customer 102 or another device. For example, I/O devices 212 may include various input/output devices, such as a keyboard, a mouse-type device, a gesture sensor, an action sensor, a physical button, switch, microphone, touchscreen panel, stylus, etc., that may be manipulated by customer 102 to input information using user device 104. I/O devices 212 may also include an audio output device, such as a speaker configured to provide sound and audio feedback to customer 102 operating user device 104. In some embodiments, I/O devices 212 may include a light emitting component, such as an LED or other component capable of providing a visible signal to customer 102. I/O devices 212 may also include haptic output devices, to provide haptic feedback to customer 102. I/O devices 204 may also include one or more communication modules (not shown) for sending and receiving information from other components in system 100 by, for example, establishing wired or wireless connectivity between user device 104, and network 106. I/O devices 212 may include a radio frequency, infrared, or other near-field communication interfaces, for communicating with other devices associated with network 106 or customer 102. Exemplary communication modules of I/O devices 212 may include, for example, a short-range or near field wireless communication modem, a Wi-Fi™ communication modem, or a cellular communication modem. I/O devices 212 may include a transceiver or transmitter configured to communicate using one or more wireless technologies/protocols that may include, without limitation, cellular (e.g., 3G, 4G, etc.) technology, Wi-Fi^{™} hotspot technology, RFID, near-field communication (NFC) or BLUETOOTH® technologies, etc. More generally, any uni- or bi-directional communication technology known to one of ordinary skill in the art may be implemented in the user device 104 to exchange information with merchant system 112, service provider system 108, or database 110 via network 106.

As described above, user device 104 may be a device that executes mobile applications for performing operations consistent with disclosed embodiments. Thus, in some embodiments, programs 206 stored on user device 104 may include one or more software applications 214 installed thereon, that enable user device 104 to communicate with service provider system 108 via network 106 and perform aspects of the disclosed methods. For example, user device 104 may connect to service provider system 108 through the use of browser software to access and receive information or perform other operations associated with an internet service provider.

According to an exemplary embodiment, software applications 214 associated with service provider system 108 may be installed on user device 104. For example, service provider system 108 may receive a request from user device 104 to download one or more software applications 214 to user device 104. In one embodiment, service provider system 108 may receive the request from customer 102, using a web browser application installed on user device 104. In another embodiment, service provider system 108 may receive the request to download one or more software applications 214 associated with service provider system 108 onto user device 104 from a webpage or another portal associated with service provider system 108 accessed by customer 102 via, e.g., user device 104. In this embodiment, service provider system 108 may store software instructions corresponding to one or more software applications 214 in database 110. For responding to the download request, service provider system 108 may receive additional information from user device 104 regarding the particular device specifications of user device 104 to enable user device 104 to download software instructions corresponding to the particular specifications. Alternatively, service provider system 108 may push a download request link to user device 104 or transmit software code corresponding to one or more software applications 214 directly to user device 104 in, for example, an e-mail, a text or short message service (SMS) message, a prompt through an app, or other suitable method. User device 104 may receive the software code related to one or more software applications 214, such as via network 108, to download and install the software code.

Applications 214 may be used by customer 102 to perform operations consistent with disclosed embodiments. For example, in some embodiments, one of applications 214 may be used by customer 102 to opt in to a prospective purchase event notification service provided by service provider system 108. Customer 102 may, according to the opt-in application, be able to select one or more of a merchant or a merchant category for which to receive notifications.

As noted above, merchant category codes associated with merchants or merchant categories are stored by service provider system 108 in database 110. The opt-in application enables display device 208 to display a list of merchants or merchant categories. If customer 102 wishes to receive prospective purchase event notifications for certain merchants or merchant categories, customer 102 may be able to select specific ones of the displayed merchants or merchant categories. The selected merchant or merchant category is communicated to service provider system 108 by user device 104 running the opt-in application and is mapped to the associated merchant category code and stored in database 110. A merchant category may include a plurality of merchants providing a specific type of goods and services. For example, stores like BestBuy® or Apple® may be grouped into a category such as “electronics”, with a specific category code. Stores like Macy's® or Sears® may be grouped into another category such as “department store”, with a different category code. For example, if customer 102 opts for prospective purchase event notifications to be sent when customer 102 visits a merchant location with the merchant category corresponding to “electronics”, the merchant category will be communicated by the opt-in application to service provider system 108. In response, service provider system 108 will map the merchant category with its merchant category code, associate the mapping with customer 102, and store the mapping in database 110. In another example, customer 102 may opt for prospective purchase event notifications to be sent when customer 102 is at a clothing store. A merchant category “clothing” will be communicated by opt-in application to service provider system 108. In response, service provider system 108 will map the merchant category with its merchant category code, associate the mapping with customer 102 and store the mapping in database 110. In some embodiments, customer 102 is optionally able to select specific merchants or locations for which customer 102 wants to receive prospective purchase event notifications. Customer 102 may opt in, using application 214, to receive prospective purchase event notifications when customer 102 enters the geofence of a specific merchant. Optionally, customer 102 may be able to opt out of receiving credit limit notifications for some merchant categories. For example, customer 102 may not want notifications delivered when customer 102 is at a restaurant or a coffee shop. In such a case, customer 102 may be able to opt out of receiving credit limit notifications for a merchant category corresponding to “restaurants” or “coffee shops”. In some embodiments, customer 102 may be able to opt out of receiving notifications at a specific location. More particularly, customer 102 may regularly visit a certain location which has multiple merchants, not for purchasing goods or services, but for other activities. For example, customer 102 may visit a gym every day at a location where there are multiple merchants. In this situation, customer 102 may not want service provider system 108 to send prospective purchase event notifications and may choose to opt out of receiving notifications at that location, e.g., the gym.

In some embodiments, customer 102 may opt for service provider system 108 to automatically send prospective purchase event notifications to customer 102 without customer 102 selecting any merchants, merchant categories or locations. The prediction model may iteratively update its algorithm with the customer specific information every time customer 102 makes a purchase using a credit card issued by the credit service provider associated with service provider system 108, to increase prediction accuracy. Service provider system 108 uses the prediction model to dynamically send notifications when customer 102 has opted for the notification service but has not made any selections with respect to a merchant, merchant category, or location.

In some embodiments, service provider system 108 may send a prospective purchase event notification to customer 102 even when customer 102 has not opted for the notification service. More particularly, service provider system 108 uses the prediction model to determine when customer 102 has utilized more than a predetermined threshold of the available credit and sends a notification to customer 102, if the prediction model predicts a prospective purchase event. In such a case, service provider system 108 uses the customer specific information of customer 102 to determine the predetermined threshold. For example, if customer 102 is a customer who often stays above a predetermined threshold, e.g., 80%, of credit utilization, customer 102 would be sent a notification so that they do not exceed their available credit, despite customer 102 not opting for the notification service. Prediction model may iteratively update its algorithm as previously described, to increase the accuracy of such determinations.

In some embodiments, the opt-in application may enable customer 102 to select a method by which to receive prospective purchase event notifications from service provider system 108. More particularly, customer 102 may be able to select a communication channel through which notifications are delivered to customer 102. Application 214 may provide a plurality of channels for delivering notifications or alerts including but not limited to text messages, SMS, phone calls, or an in-app notification, for customer 102 to choose. Customer 102 may be able to choose the method of notification delivery using application 214, including haptic or vibration alerts, sound alerts, silent alerts, etc. Notifications may appear on user device 104 in the form of an icon, a badge on the icon of application 214, a status bar format, or as a more detailed message on display device 208. Customer 102 may be able to choose an appearance of the notification. Once customer 102 selects a channel of notification delivery, customer 102 may further select a method and appearance of notification individually or in combination with each other, using application 214. For example, if customer 102 selects only haptic or vibration alerts, user device 104 will vibrate but will neither make any sound nor will it display a detailed message. When customer 102 selects only sound alerts, user device 104 will make a sound, but will neither vibrate nor display a detailed message. Customer may also select vibration and sound alerts together causing user device 104 to vibrate while making a sound to deliver notifications to customer 102. Alternatively, customer 102 may select notifications to be displayed without any sound or vibration alerts with only display of an icon, a badge on the icon of application 214, a status bar, or as a more detailed message depending on the selection of customer 102. Alternatively, customer 102 may be able to select notifications to be delivered using sound alerts, vibration alerts and display messages altogether.

In some embodiments, application 214 may further provide a snooze option to customer 102. Customer 102 may be able to turn the notifications off for a predetermined amount of time, if customer 102 does not want to be disturbed. Alternatively, service provider system 108 may determine that customer 102 is not going to make a purchase for the next few hours and dynamically activate the snooze option. For example, when service provider system 108 determines that customer 102 is stationary at a predetermined location including but not limited to home, work, gym, etc., for a predetermined amount of time, based on customer specific information, e.g., customer routine information, service provider system 108 is able to dynamically activate the snooze option.

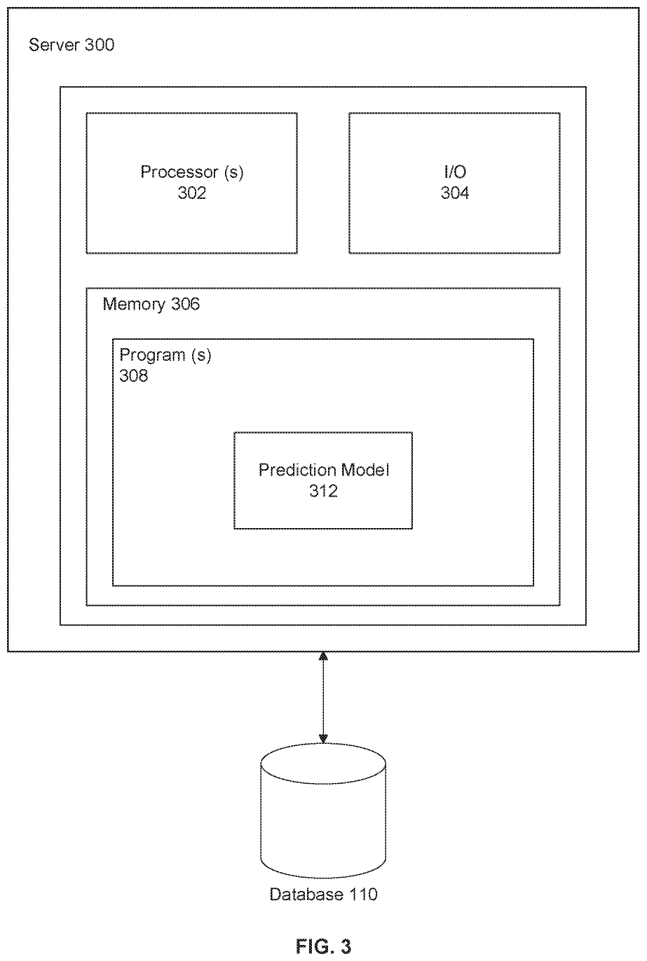

FIG. 3 shows an exemplary server 300 consistent with the disclosed embodiments. Variations of exemplary server 300 may constitute one or more components of service provider system 108 and/or merchant system 112. In one embodiment, server 300 includes one or more processors 302, one or more input/output (I/O) devices 304, and one or more memories 306. In some embodiments, server 300 may be a part of service provider system 108. In some embodiments, server 300 may take the form of a specially programmed server or computing system used by service provider system 108. In some embodiments, server 300 may be configured as an apparatus, embedded system, dedicated circuit, and the like based on the storage, execution, and/or implementation of the software instructions that perform one or more operations consistent with the disclosed embodiments.

Processor 302 may include one or more known processing devices, such as a microprocessor from the Pentium™ or Xeon™ family manufactured by Intel™, or the Turion™ family manufactured by AMD™, for example. The disclosed embodiments are not limited to any type of processor(s) otherwise configured to meet the computing demands required of different components of system 100.

Memory 306 may include one or more storage devices configured to store instructions used by processor 302 to perform functions related to disclosed embodiments. For example, memory 306 may be configured with one or more software instructions, such as program(s) 308 that may perform one or more operations when executed by processor 302. The disclosed embodiments are not limited to separate programs or computers configured to perform dedicated tasks. For example, memory 306 may include a single program 308 that performs the functions of system 300, or program 308 may comprise multiple programs. In certain embodiments, memory 306 may store sets of instructions or programs 308 for determining a location of customer 102, determining if customer 102 is at a merchant location, and providing real-time credit limit notifications based on the location and identity of customer 102. These sets of instructions may be executed by processor 302 to perform communication and/or processes consistent with disclosed embodiments. In certain embodiments, when server 300 constitutes one or more of the components of service provider system 108, memory 306 includes a prediction model 312, corresponding to the above described prediction model, which uses machine learning to predict the possible occurrence of a prospective purchase event associated with customer 102 using one or more items of the customer specific information including customer transaction data, customer mobility data and/or customer segmentation data, as well as using merchant data. Prediction model 312 may employ various machine learning techniques including decision tree learning, association rule learning, artificial neural networks, inductive logic programming, support vector machines, clustering, Bayesian networking, reinforcement learning, representation learning, similarity and metric learning, spare dictionary learning, rule-based machine learning, etc. Predicting the occurrence of a prospective purchase event includes predicting if customer 102 is going to make a purchase, a monetary amount of the purchase and predicting if the purchase may result in the purchase transaction exceeding the available credit of customer 102. If prediction model 312 predicts that the purchase will result in the purchase transaction exceeding the available credit, a prospective purchase event occurs and service provider system 108 sends a prospective purchase event notification to customer 102. As noted above, prediction model 312 may iteratively update its algorithm with customer specific information each time customer 102 makes a purchase, to increase prediction accuracy.

Server 300 may also be communicatively coupled to one or more database(s) 110. In one aspect, server 300 may include database 110. Alternatively, database 110 may be located remotely from server 300 and server 300 may be communicatively coupled to database(s) 110 through network 106.

In some embodiments, prediction model 312 may utilize machine learning to update and adjust its algorithm using the location of customer 102 and the customer specific information in real-time. For example, service provider system 108 may determine that customer 102 is at a first merchant location and then use prediction model 312 to determine that customer 102 is going to make a purchase, and determine that the monetary amount of the purchase will not exceed the available credit, so that a prospective purchase event will not occur at the first merchant location. Customer 102 then proceeds to a second merchant location and service provider system 108 uses prediction model 312 to determine the occurrence of a prospective purchase event at the second merchant location. Based on the purchase transaction at the first location, i.e., the most recent purchase transaction, prediction model 312 updates its algorithm in real time to include the most recent customer transaction data, customer mobility data, and merchant data. Prediction model 312 then determines the occurrence of the prospective purchase event at the second merchant location, because of the purchase made at the first merchant location. Based on this determination, service provider system 108 will send a prospective purchase event notification to customer 102, because the monetary amount of the predicted purchase transaction at the second merchant location will exceed the updated available credit, which was reduced based on the purchase transaction at the first merchant, and will likely result in the purchase transaction being declined.

In some embodiments, service provider system 108 uses prediction model 312 to predict if a notification needs to be sent, based on a shopping journey of customer 102. For example, customers often shop at a shopping mall where there are multiple merchants within a single geofence 114, as shown in FIG. 1. It is not ideal if customer 102 receives notifications regarding a prospective purchase event every time customer 102 walks past one of the merchant shops. In this situation, service provider system 108 determines that customer 102 has entered geofence 114, and there is a shopping mall within geofence 114, in the manner explained in previous embodiments. Service provider system 108 may use prediction model 312 to determine if a notification needs to be sent only when a time duration of customer 102 within a particular merchant location exceeds a predetermined threshold. For example, when service provider system 108 determines that customer 102 is on a shopping journey at a shopping mall, it increases the frequency of sending location access requests to user device 104 associated with customer 102. This enables service provider system 108 to determine when the time duration of customer 102 within a particular merchant location exceeds the predetermined threshold. In some embodiments, the threshold may be dynamically determined based on customer identity information, customer financial account information, customer specific information including customer transaction data, customer mobility data, and/or merchant data associated with the particular merchant location.

In some embodiments, service provider system 108 determines the frequency at which the location access request is periodically sent based on the routine of customer 102. Prediction model 312 is trained to identify certain days when customer 102 is more inclined to make a purchase transaction at a particular merchant location. For example, customer 102 may regularly visit a shopping mall on a specific day of the week and makes purchase transactions at certain merchant locations within the shopping mall. Service provider system 108 will store customer specific information for customer 102 including but not limited to, for prior purchase transactions by customer 102, merchant location, time and date of purchase, monetary amount of purchase, merchant category, etc. This information is retrieved by prediction model 312 to learn routine behavior of customer 102 on the specific day of the week. Prediction model 312 will use this information to determine if that specific day of the week is a potential “high spending” day for customer 102. Based on this determination, service provider system 108 increases the frequency at which it sends location access requests to customer 102 on that specific day of the week. If the location access response indicates that customer 102 is in fact at the shopping mall, service provider system 108 uses prediction model 312 to predict a possible prospective purchase event. If prediction model 312 predicts a prospective purchase event, service provider system 108 will send a prospective purchase event notification to customer 102. In other embodiments, customer 102 may visit the shopping mall every Saturday but not make a purchase. The purpose of the visit could be to visit the gym, meet friends, or do something other than make a purchase at a merchant location. Prediction model 312 determines this behavior of customer 102 and updates its algorithm such that service provider system 108 does not need to send a notification to customer 102.

In some embodiments, every time customer 102 makes a purchase using a credit card provided by the credit service provider associated with service provider system 108, prediction model 312 updates its algorithm to learn the actions of customer 102. For example, if customer 102 makes a purchase at an online merchant using the merchant website or any other web-based or mobile application, and only visits the brick and mortar merchant location to return the purchased item, customer 102 will be issued a refund by the merchant during the visit. When prediction model 312 determines that customer 102 is at the brick and mortar merchant location to return the goods purchased online, prediction model 312 updates its algorithm to include this behavior of customer 102. Over time, prediction model 312 learns the merchant locations that customer 102 frequently visits for returning goods purchased online and does not predict a potential purchase, so that service provider system 108 does not need to send a notification to customer 102 in relation to such visits.

In some embodiments, service provider 108 does not have substantial customer specific information associated with customer 102 for use by prediction model 312 to predict the occurrence of a purchase event. In such situation, service provider system 108 can access the customer segmentation data. Prediction model 312 uses the customer segmentation data to predict the possible occurrence of a prospective purchase event. Customer segmentation data includes customer specific data associated with customers sharing characteristics similar to characteristics of customer 102. Customer segmentation is performed by service provider system 108 dividing customers into sub-groups or segments based on shared characteristics. Shared characteristics are divided into primary characteristics and secondary characteristics. Customer segmentation data includes primary characteristics of a plurality of customers which are similar to primary characteristics of customer 102 and secondary characteristics of a plurality of customers which are similar to secondary characteristics of customer 102. Primary characteristics include, for example, customer mobility data, customer transaction data, and merchant data. Secondary characteristics include, for example, demographic data including but not limited to age, gender, nationality, income, family size, marital status, occupation, religion, race, ethnicity, education, etc. Primary characteristics and secondary characteristics are collected by service provider system 108 from a plurality of customers and stored in database 110.

When service provider 108 does not have substantial information associated with customer 102, prediction model 312 uses primary characteristics alone or in combination with the customer specific information related to customer 102 to predict the possible occurrence of a prospective purchase event.

In some embodiments, prediction model 312 may not be able to predict the possible occurrence of a prospective purchase event using the customer specific information related to customer 102 alone or in combination with the primary characteristics of customer segmentation data. In such cases, prediction model 312 uses secondary characteristics alone or in combination with the customer specific information related to customer 102 and the primary characteristics to predict the possible occurrence of a prospective purchase event.

In some embodiments, prediction model 312 uses merchant store hours in addition to one or more of the customer transaction information, and/or customer mobility data to predict the possible occurrence of a prospective purchase event. For example, customer 102 is at the shopping mall to watch a late-night movie. Service provider system 108 determines the location of customer 102 as being at the shopping mall. Prediction model 312 uses the location of customer 102 and the merchant data which includes merchant hours, to predict that the merchants are not open for business and in turn predicts that a prospective purchase event is not going to occur. As a result, service provider system 108 does not need to send a notification to customer 102.

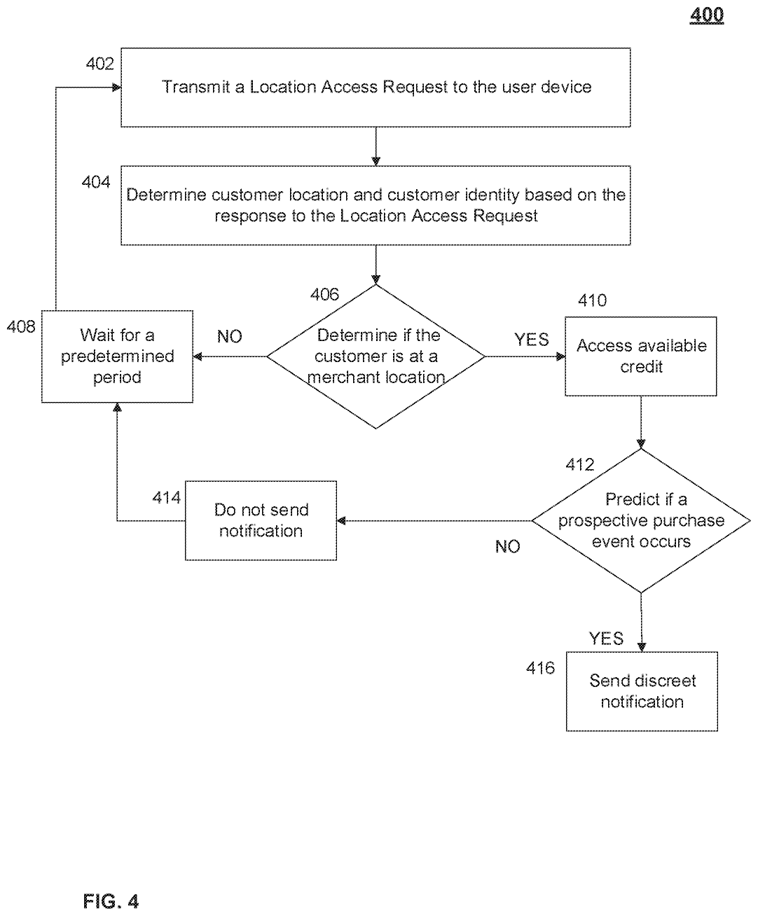

FIG. 4 is a flowchart of an exemplary process 400 to send a location based prospective purchase event notification to customer 102, consistent with the disclosed embodiments. In certain aspects, server 300 may be configured to execute software instructions that perform one or more of the operations of process 400.

In accordance with process 400, service provider system 108 transmits a location access request to user device 104 (402). At 404, service provider system 108 receives from user device 104 a response to the location access request, including information regarding the location of user device 104. Service provider system 108 is configured to determine the location and identity of customer 102 based on the received response (404). Based on the determined location in step 404, service provider system 108 determines if customer 102 is at a merchant location (406). In making this determination, service provider system 108 uses the merchant data stored in database 110 to determine if customer 102 is at a merchant location, as previously described.

When service provider system 108 determines that customer 102 is not at a merchant location (406—NO), service provider system 108 waits for a predetermined time period before transmitting another location access request to user device 104 (408). The predetermined time period is based on the frequency of sending location access requests determined by service provider system 108, as previously described. For example, if service provider system 108 determines the location of customer 102 to be his/her workplace on a weekday morning, service provider system 108 reduces the frequency of transmitting location access requests, thereby increasing the time period for which service provider system 108 may wait before transmitting another location access request. In this situation, service provider system 108 may wait a few minutes or hours, based on the routine of customer 102, before transmitting the next location access request.

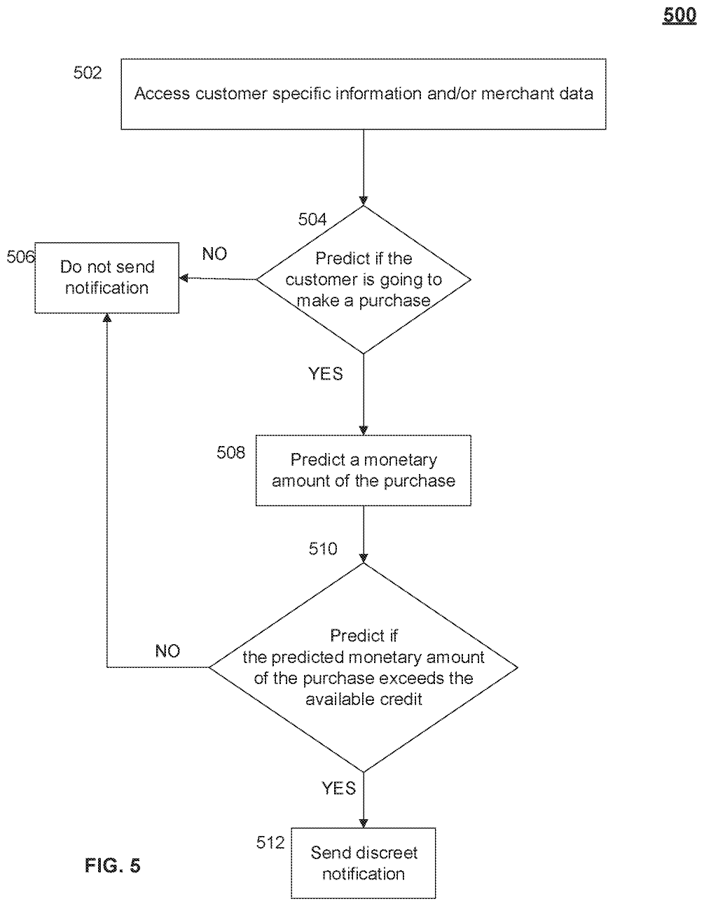

When service provider system 108 determines that customer 102 is at a merchant location (406—YES), service provider system 108 uses the determined identity of customer 102 to access an available credit of customer 102 (410). Based on the available credit of customer 102, service provider system 108 uses prediction model 312 to predict if a prospective purchase event will occur (412). The process of predicting the occurrence of a prospective purchase event is described below with reference to FIG. 5. When prediction model 312 predicts a prospective purchase event (412—YES), service provider system 108 sends discreet prospective purchase event notification to customer 102 on user device 104 as previously described, (416). When prediction model 312 does not predict a prospective purchase event (412—NO), service provider system 108 does not send a notification to customer 102 (step 414) and waits for the predetermined time period before transmitting another location access request. (408).

FIG. 5 is a flowchart of an exemplary process 500 to predict the occurrence of a prospective purchase event and send a location based prospective purchase event notification to customer 102, consistent with the disclosed embodiments. In some embodiments, service provider system 108 uses prediction model 312 to perform process 500 to predict the occurrence of a purchase event. In certain aspects, server 300 may be configured to execute software instructions that perform one or more of the operations of process 500.

At step 412 in FIG. 4, service provider system 108 uses prediction model 312 to predict whether a prospective purchase event will occur based on, among other things, the location and available credit of customer 102. Prediction model 312 accesses customer specific information including customer transaction data and customer mobility data, as well as merchant data (502). Prediction model 312 uses the customer specific information and merchant data to determine if customer 102 is going to make a purchase (504), as previously described.

When prediction model 312 predicts that customer 102 is not going to make a purchase (504—NO), service provider system 108 does not send a notification to customer 102 (506). Referring to FIGS. 4 at 414 and 408, service provider system 108 waits for a predetermined time period to send another location access request, as previously described. When prediction model 312 predicts that customer 102 is going to make a purchase (504—YES), prediction model 312 predicts the monetary amount of purchase based on the accessed customer specific information and merchant data (508). Prediction model 312 further predicts if the predicted monetary amount of the purchase will exceed the available credit of customer 102 (510).

When prediction model 312 predicts that the predicted monetary amount of the purchase will not exceed the available credit of customer 102 (510—NO), service provider system 108 does not send notification to customer 102 (step 506). Referring to FIGS. 4 at 414 and 408, service provider system 108 waits for a predetermined time period to send another location access request, as previously described. When prediction model 312 predicts that the predicted monetary amount of the purchase will exceed the available credit of customer 102 (510—YES), a prospective purchase event occurs. In this case, service provider system 108 sends a discreet prospective purchase event notification to customer 102 on user device 104 as previously described (512).

The above embodiments of the invention disclose benefits for customers with lower credit limits, first time card holders, or high spenders. As described above, customers are able to receive discreet notifications, before they make a purchase, which helps them from going over their available credit. Since the customers are able to receive automatic notifications, they don't have to worry about checking their credit card accounts before every credit purchase. The invention can be a solution for problems including but not limited to credit card decline, over-limit fees, unnecessary credit line changes, reduction in credit score, etc. The discreet notification system, as described above, can also avoid embarrassment caused to the customers if their credit card is declined while at a merchant location.

While illustrative embodiments have been described herein, the scope thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified. Thus, the foregoing description has been presented for purposes of illustration only. It is not exhaustive and is not limiting to the precise forms or embodiments disclosed. Modifications and adaptations will be apparent to those skilled in the art from consideration of the specification and practice of the disclosed embodiments.

The elements in the claims are to be interpreted broadly based on the language employed in the claims and not limited to examples described in the present specification or during the prosecution of the application, which examples are to be construed as non-exclusive. It is intended, therefore, that the specification and examples be considered as exemplary only, with a true scope and spirit being indicated by the following claims and their full scope of equivalents.

1. A system for location based available credit notification, the system comprising:
one or more memory devices storing instructions; and
one or more processors in communication with one or more databases configured to execute the instructions to:
determine a customer location and a customer identity, associated with a user device of a customer of a credit service provider, based on responses from the user device to periodic location access requests by the one or more processors, the frequency of the requests based on a duration for which the user device is at the location, wherein the frequency varies based on the location and a predetermined duration threshold;
determine an available credit associated with the customer based on the determined customer identity;
access customer specific information and merchant data based on at least one of the determined available credit, the customer location, and the customer identity;
wherein the customer specific information and merchant data are accessed in the one or more database, and
wherein the customer specific information includes at least one of customer transaction data or customer mobility data;
predict, by a prediction model using the customer specific information and the merchant data, if the customer is going to make a purchase and, if so, a monetary amount of the purchase;
determine if the predicted monetary amount of the purchase exceeds the available credit associated with the customer;
determine that the customer has elected to receive a notification;
transmit the notification to the user device upon determining that the predicted monetary amount of the transaction exceeds the available credit, and that the customer has elected to receive the notification; and
iteratively update the prediction model with the customer specific information when the customer makes the purchase.

2. (canceled)

3. The system of claim 1 wherein the merchant data includes merchant location or merchant category

4. The system of claim 1 wherein the one or more processors are further configured to receive a selection by the customer for receiving the notification for one or more of merchant, location, or merchant category.

5. The system of claim 1 wherein the customer transaction data includes one or more of purchase history or refund history.

6. The system of claim 1 wherein the customer mobility data includes one or more of travel history, routine, frequently visited locations, or travel route of the customer.

7. The system of claim 1 wherein the one or more processors are further configured to locate the customer in a three-dimensional environment of an indoor environment or an outdoor environment.

8. The system of claim 1 wherein the one or more processors are further configured to determine the customer location using one or more location determination technologies including GPS, Wi-Fi, Bluetooth, RFID, or a proximity sensor.

9. The system of claim 1 wherein the one or more processors are further configured to receive a selection by the customer for a method of notification.

10. A computer implemented method for location based available credit notification, the method comprising:
determining, by one or more processors, a customer location and a customer identity, associated with a user device of a customer of a credit service provider, based on a response from the user device to a location access request;
determining a customer location and a customer identity, associated with a user device of a customer of a credit service provider, based on responses from the user device to periodic location access requests by the one or more processors, the frequency of the requests based on a duration for which the user device is at the location, wherein the frequency varies based on the location and a predetermined duration threshold;
determining an available credit associated with the customer based on the determined customer identity;
accessing customer specific information and merchant data based on at least one of the determined available credit, the customer location, and the customer identity;
wherein the customer specific information and merchant data are accessed in the one or more databases, and
wherein the customer specific information includes at least one of customer transaction data or customer mobility data;
predicting, by a prediction model using the customer specific information and merchant data, if the customer is going to make a purchase and, if so, a monetary amount of the purchase;
determining if the predicted monetary amount of the purchase exceeds the available credit associated with the customer; determining that the customer has elected to receive a notification;
transmitting the notification to the user device upon determining that the predicted monetary amount of the transaction exceeds the available credit, and that the customer has elected to receive the notification; and
iteratively updating the prediction model with the customer specific information when the customer makes the purchase.

11. (canceled)

12. The method of claim 10 wherein the merchant data includes merchant location or merchant category.

13. The method of claim 10 further including receiving a selection by the customer for receiving the notification for one or more of merchant, location, or merchant category.

14. The method of claim 10 wherein the customer transaction data includes one or more of purchase history or refund history.

15. The method of claim 10 wherein the customer mobility data includes one or more of travel history, routine, frequently visited locations, or travel route of the customer.

16. The method of claim 10 further including locating the customer in a three-dimensional environment of an indoor environment or an outdoor environment.

17. The method of claim 10 further including determining the customer location using one or more location determination technologies including GPS, Wi-Fi, Bluetooth, RFID, or a proximity sensor.

18. The method of claim 10 further including receiving a selection by the customer for a method of notification.

19. A non-transitory computer-readable medium storing instructions executable by one or more processors to perform operations for location based available credit notification, the operations comprising:
determining a customer location and a customer identity, associated with a user device of a customer of a credit service provider, based on a response from the user device to a location access request;
determining a customer location and a customer identity, associated with a user device of a customer of a credit service provider, based on responses from the user device to periodic location access requests by the one or more processors, the frequency of the requests based on a duration for which the user device is at the location, wherein the frequency varies based on the location and a predetermined duration threshold;
determining an available credit associated with the customer based on the determined customer identity;
accessing customer specific information and merchant data based on at least one of the determined available credit, the customer location, and the customer identity;
wherein the customer specific information and merchant data are accessed in the one or more databases, and
wherein the customer specific information includes at least one of customer transaction data or customer mobility data;
predicting, using the customer specific information and merchant data, if the customer is going to make a purchase and, if so, a monetary amount of the purchase;
determining if the predicted monetary amount of the purchase exceeds the available credit associated with the customer;
determining that the customer has elected to receive a notification;
transmitting the notification to the user device upon determining that the predicted monetary amount of the transaction exceeds the available credit, and that the customer has elected to receive the notification; and
iteratively updating the prediction model with the customer specific information when the customer makes the purchase.

20. (canceled)
